(19) United States
(12) Patent Application Publication
(10) Pub. No.: US 2008/0167929 A1
(43) Pub. Date: Jul. 10, 2008

(54) METHOD AND STRUCTURE FOR GENERIC ARCHITECTURE F0R INTEGRATED END-TO-END WORKFORCE MANAGEMENT

(76) Inventors: Heng Cao, Yorktown Heights, NY (US); Daniel Patrick Connors, Pleasant Valley, NY (US); Donna L. Gresh, Cortlandt Manor, NY (US); Meng-Chen Hsieh, Elmhurst, NY (US); Jianying Hu, Bronx, NY (US); Chen Jiang, Mohegan Lake, NY (US); Tarun Kumar, Mohegan Lake, NY (US); Yang Liu, Mohegan Lake, NY (US); Yingdong Lu, Yorktown Heights, NY (US); Aleksandra Mojsilovic, New York, NY (US); Ana Radovanovic, New York, NY (US); Mark S. Squillante, Pound Ridge, NY (US); Yichong Yu, Yorktown Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/621,942

(22) Filed: Jan. 10, 2007

(51) Int. Cl. G06Q 10/00

(52) U.S. Cl. 705/8

(57) ABSTRACT

A method (and structure) for end-to-end workforce management, includes identifying sources of data that together reflect data of substantially the entirety of a workforce of an organization, identifying service components related to the workforce, and combining the data sources and service components into an integrated framework to support an end-to-end workforce management cycle.

### CROSS-REFERENCE TO RELATED APPLICATIONS

The present Application is related to the following co-pending applications:

U.S. Patent application Ser. No. 11/___,___, filed on ______, to Cao et al., entitled “Method and Apparatus for End-to-End Workforce Management”, having IBM Docket YOR920060548US1; and

U.S. patent application Ser. No. 11/375,001, filed on Mar. 15, 2006, to Lu et al., entitled “Method and Structure for Risk-Based Workforce Management and Planning”, having IBM Docket YOR920050557US1,

both assigned to the present assignee, and both incorporated herein by reference.

### BACKGROUND OF THE INVENTION

1. Field of the Invention

The present invention generally relates to a method and tool for workforce management. More specifically, a generic architecture is provided for achieving an integrated end-to-end workforce management and which architecture can serve as a framework and foundation for an integrated workforce management tool.

2. Description of the Related Art

It has been said repeatedly that business success in the 21st century will be based on the caliber of the workforce, a workforce that is global, diverse and constantly changing in terms of skill distribution, work experience, geography, etc. Because of these factors, managing the workforce is becoming increasingly complex.

For example, the assignee of the present application has close to 350,000 employees. This workforce is global and is constantly changing in age, skills, and geographies. The management of this workforce clearly affects customer responsiveness, the ability to deliver goods and services, and the assignee's bottom line.

It is noted that 50% of the U.S. government workforce will be eligible to retire in the next 5-7 years. Additionally, more than 450 CEOs surveyed worldwide indicated growth as being their top strategic priority for the next 2-3 years. Their biggest human challenge is the lack of skills of their employees and the shortage of qualified workers.

Thus, the issue of workforce management is becoming one of the most important factors in any company's ability to deliver projects, grow revenue, and be more profitable. Therefore, companies today face the challenge of understanding how to optimize their workforce to yield the greatest business value, and forward-thinking businesses are investing in workforce optimization methodologies and solutions as a major competitive differentiator. Today, having inadequately staffed projects can be even more costly than having surplus inventory or empty shelves.

Today there are numerous solutions, software systems and services that are designed to support or fully automate some components of the workforce management cycle. Examples include systems for demand forecasting, scheduling tools, planning tools, etc.

Yet, although the true value of workforce optimization lies in the ability to support (and even automate) the entire workforce management cycle within an organization, there are no such integrated full-fledge solutions, primarily due to the lack of a flexible architecture that would allow the implementation of different workforce management components and tools within one.

Thus, a need exists for a tool that provides end-to-end integrated workforce management in a manner that optimizes that workforce potential.

### SUMMARY OF THE INVENTION

In view of the foregoing, and other, exemplary problems, drawbacks, and disadvantages of the conventional systems, it is an exemplary feature of the present invention to provide a structure (and method) that provides a framework and foundation for end-to-end workforce management.

It is another exemplary feature of the present invention to provide a structure and method wherein all data throughout an organization that is related to workforce management is identified and provided into a unified repository.

It is another exemplary feature of the present invention to identify all components within an organization (e.g., stakeholders) which will benefit from or relies upon access to at least a portion of the data in the unified data repository.

It is another exemplary feature of the present invention to develop service components to service those stakeholders of the organization, along with appropriate user interfaces.

It is another exemplary feature of the present invention to provide this framework of integrated data, service components, and user interfaces as a foundation for end-to-end workforce management.

It is another exemplary feature of the present invention to provide this framework as a foundation for an end-to-end workforce management tool.

Therefore, in a first exemplary aspect of the present invention, described herein is a method of creating a generic architecture for end-to-end workforce management, including identifying sources of data that together reflect data of substantially an entirety of a workforce of an organization; identifying service components related to the workforce; and combining the data sources and service components into an integrated framework to support an end-to-end workforce management cycle.

In a second exemplary aspect of the present invention, also described herein is a method of implementing an integrated end-to-end workforce management framework, including at least one of designing and implementing: an extensible infrastructure for implementing a plurality of individual service components related to the workforce; an extensible multi-component infrastructure to support interactions among the service components; a unified data model to accommodate automatic data feeds, multiple data sources, and human inputs related to the workforce; and a data flow control mechanism.

In a third exemplary aspect of the present invention, also described herein is an integrated end-to-end workforce management framework that results from the afore-described method.

Thus, from the foregoing description, the present invention provides a workforce management technique and mechanism that provides many benefits including scalability and reusability, so that the system can grow seamlessly and quickly integrate new users, interfaces, solutions, and capabilities and can easily be reconfigured to address a variety of workforce applications.

### BRIEF DESCRIPTION OF THE DRAWINGS

The foregoing and other purposes, aspects and advantages will be better understood from the following detailed description of an exemplary embodiment of the invention with reference to the drawings, in which:

FIG. 1 shows a number of exemplary challenges 100 related to the problem of workforce management that is addressed by the present invention;

FIG. 2 shows an exemplary end-to-end workforce management architecture 200 of the framework of the present invention;

FIG. 3 shows an exemplary system integration J2EE architecture 300 for the present invention, including an exemplary end-to-end workforce tool built upon the framework of the present invention;

FIG. 4 shows exemplarily how data integration 400 can be achieved in the present invention;

FIG. 5 shows an exemplary flowchart 500 of a methodology for the integrated end-to-end workforce management framework;

FIG. 6 illustrates an exemplary hardware/information handling system 600 that could be used for implementing the present invention therein; and

FIG. 7 illustrates a signal bearing medium 700 (e.g., storage medium) for storing steps of a program of the method according to the present invention.

### DETAILED DESCRIPTION OF AN EXEMPLARY EMBODIMENT OF THE INVENTION

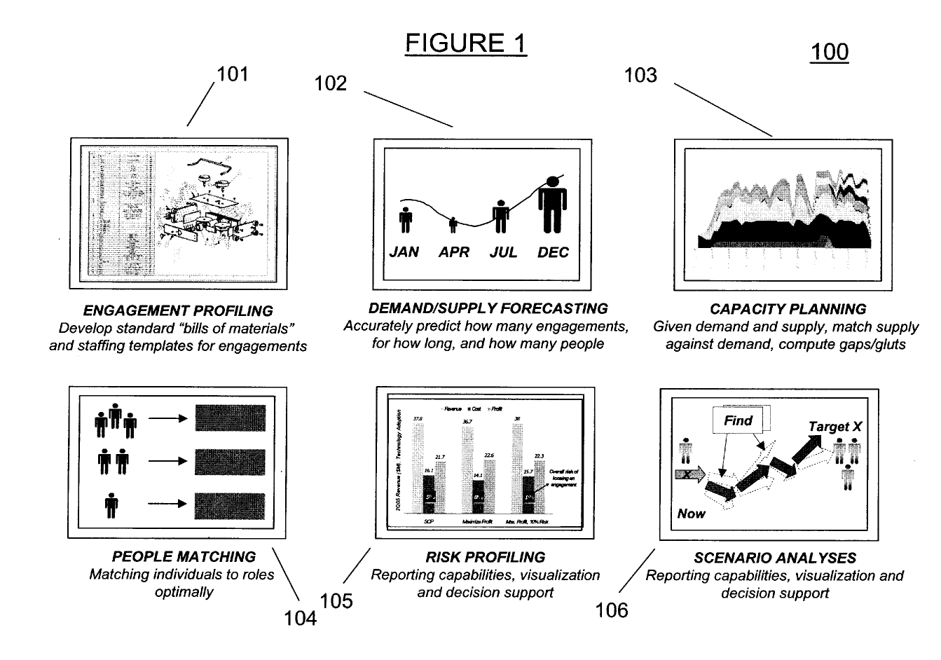

Referring now to the drawings, and more particularly to FIGS. 1-7, an exemplary embodiment of the present invention will now be described.

To begin with, when the area of workforce management is considered, there are so many issues one can work on. FIG. 1 illustrates some examples of issues that might be considered in workforce management, as follows.

Engagement profiling (101): If one were to take the supply chain approach in managing a workforce, one of the first things needed to be developed is a methodology to construct “bills of materials” for our engagements. For example, one can apply advanced clustering and statistical analysis techniques to the historical data on projects, in order to find common patterns in terms of their skill and job role mix, and create a standardized taxonomy for projects on the basis of their resource requirements.

Demand/Supply forecasting (102): One of the key issues in workforce management is the ability to accurately forecast the demand for resources (how many projects we expect, for how long, and with how many people) and the supply of resources (attrition, people making changes in their skills).

Capacity planning (103): Based on the demand forecast and a bill of materials for projects/engagements, one can look ahead (either on a short term or a long-term horizon) and predict future excesses and shortages (i.e. “gaps” and “gluts”) in the workforce, and provide hiring, firing, training, and re-skilling recommendations. One can also use advanced optimization techniques to account for uncertainty in demand and to compute optimal capacity plans that maximize some business objective (e.g., profit). The second of the above-identified co-pending applications describes a method and tool that is related to this aspect of the present invention.

Matching people to projects (104): Given immediate needs for staffing the projects, one needs to be able to match individuals to roles in an “optimal fashion”, taking account into specific preferences and business rules (such as skill combination, travel, availability, geographical location, etc). One example is a tool that uses existing constraint satisfaction technology to fill the “open seats”, or to replace positions occupied by contractors with regular employees.

Risk profiling (105): One can use advanced probabilistic models to allow for support in decision-making. For example, for selected staffing levels, one can compute the overall risk of revenue loss, revenue loss for individual project types, or compute the staffing levels that correspond to the selected risk preferences.

Scenario Analyses (106): Advanced reporting capabilities and visualization to provide visibility into the workforce decision to all stakeholders (e.g., people who do planning, delivery, sales, executives, etc.). Examples include revenue realization/trends in the solution portfolio, relationship between planned and realized revenue by sector/solution, relationship between planned and actual staffing, correlation between staffing and project quality, and various analytical capabilities to support decision making.

Often described as “the right person in the right place at the right time at the right price”, an “ideal” workforce optimization solution will combine managerial discipline with advanced analytics and information technology (IT). Such solutions would be able to produce everything from the forecast of the future demand for resources, and the future supply of resources, skills taxonomies, “perfectly staffed” and timely delivered projects, and efficiently deployed workers, to the interlocked sales, planning and delivery organizations—all enabled by an integrated, secure, global network. However, despite the proliferation of workforce analytics, such full-fledge solutions are still rare.

Most existing solutions focus on one aspect of the workforce optimization, or one business process within the workforce lifecycle, e.g. demand forecasting, scheduling, etc. Such solutions are designed to locally “optimize” selected business processes, thus being “myopic” with respect to optimizing a global business objective of the entire organization. In order to have an effective integrated workforce management, there remains a need for a set of designs and methods that will optimize both the local business process of each stakeholder and the global business objective of the entity.

The present invention describes a generic architecture that supports and implements an integrated workforce management system. The first of the two above-identified co-pending applications describes details of a specific implementation for an integrated end-to-end workforce management method, system, and tool that can be implemented on the foundation of the integrated framework of the present invention.

The methodology of the present invention specifies a set of steps that enables the design and implementation of an integrated framework and architecture upon which such a specific integrated end-to-end workforce management tool can be implemented, including:

designing extensible infrastructure for implementing individual service components (e.g., providing a generalized “wrapper” for a service component, in an exemplary preferred embodiment, that includes specifying the semantics of inputs/outputs that define the service);

designing extensible multi-component infrastructure to support interactions among the service components (e.g., in an exemplary preferred embodiment, defining the data syntax to support the interaction of service components);

designing a unified data model to accommodate automatic data feeds, multiple data sources and human inputs (e.g., designing a data model that describes workforce data entities that can handle various data types and formats, e.g., manual entry, flat file, db entry);

unified environment to accommodate human intervention;

data control flow (e.g., define role-based access controls and interventions. For example, for each data source and service component can have an “owner” and “reviewer” role with different access privileges, who can update the data or run the service versus automatic update);

allowing for easily adding new service components, users, and interfaces; and

allowing for various modes of operation (e.g., hosted versus standalone, on line versus off line).

Given the generic architecture and framework of the present invention, a specific workforce management tool, such as exemplarily described in the first of the above-described co-pending applications can be implemented, to thereby provide a mechanism that utilizes the integration capabilities of this framework and can even further enhance its integration capabilities by adding optimization capabilities.

Workforce optimization and management is not only about the local management of business processes within the workforce cycle—it requires an integrated approach that will enable a true workforce management lifecycle. An integrated solution that spans the entire workforce cycle of an organization could deliver numerous benefits including:

1) Compressed planning cycle time, including the ability to react to sudden changes in demand and supply.

2) Improved accuracy of staffing decisions and more accurate resource analysis, including uniform, standard and up-to-date views of the workforce. Workforce tools can be managed globally.

3) Minimized risk of engagement loss, and better utilization, including optimized management of resources to opportunities. Training decisions can be linked to forecasted shortages. People can be optimally matched to opportunities.

4) Clearer picture of customer patterns.

5) Linkage between demand inputs, staffing recommendations, and business performance.

6) Informed staffing strategy through continuous analysis of staffing patterns and performance.

7) Visibility into the workforce management process for all stakeholders and decision makers.

8) Better forecasting, including analytic projections of workforce trends and accurate projections of pipelines (short, mid and long-term).

The present invention provides a foundation to achieve a design of an integrated workforce management tool (systems) which has never existed before. Through such integrated tool, an example of which is described in the first above-identified co-pending application, more advantages have been provided than just simply putting a set of stand alone tools together, since the method of the present invention allows one to optimize across different models based on consistent data. Additionally, user interface design can take a more user-centric approach to make sure the information is best presented to end user, and a user only needs to focus on the business domain while leaving model parameter tuning and calibration to the integrated tool.

However, it is noted that the framework of the present invention is not intended as limited to application of any specific mechanism, such as described in the first above-described co-pending application, since other specific tools and mechanisms would also benefit from the integrated foundation of the present invention. Indeed, the integrated foundation of the present invention provides a fundamental management mechanism that can benefit an organization with only minor user interface to permit users to access to the organization's integrated data sources.

Therefore, the solution of the present invention includes a layered architecture and framework for workforce management that supports:

integration across multiple data sources, databases and way of inputting data (e.g., DB2, human entry, lotus notes db, flat files, etc.)

multiple service components (e.g., demand forecasting, resource assignment, etc.)

interactions across service components (demand forecasting, resource assignment, etc.)

multiple user interfaces.

interaction and relationships across different user communities (e.g., reporting capabilities, alerts, and notifications, etc.)

access control management (e.g., role-based access views, read/write privileges)

adding new service components, users, and interfaces.

The techniques of the present invention is somewhat related to the two above-identified co-pending applications, as follows.

Relative to the first co-pending application, the present invention is one example of a generic framework upon which the more specific tool described in this co-pending application can be implemented. However, the present invention is not intended as being limited to use by only the specific tool of this co-pending application, since the generic framework of the present invention can even stand alone or be used with other specific tools.

That is, the present invention can be viewed as teaching a generic integrated framework that can be expanded to incorporate any of possible specific tools, such as described in the co-pending application, that provides user interfaces and enhanced features such as optimization capabilities. Alternatively, the end-to-end integrated approach discussed herein can be implemented as an integrated managerial system concept without any additional specific tools. Moreover, if additional tools are used in the implementation of the generic approach of the present invention, such tools are not limited to the specific example described in the first co-pending application

Relative to the second above-identified co-pending application, this second co-pending application provides one example of concept of risk-based methods that could be incorporated as modules in a tool used in coordination with the generic integrated approach of the present invention.

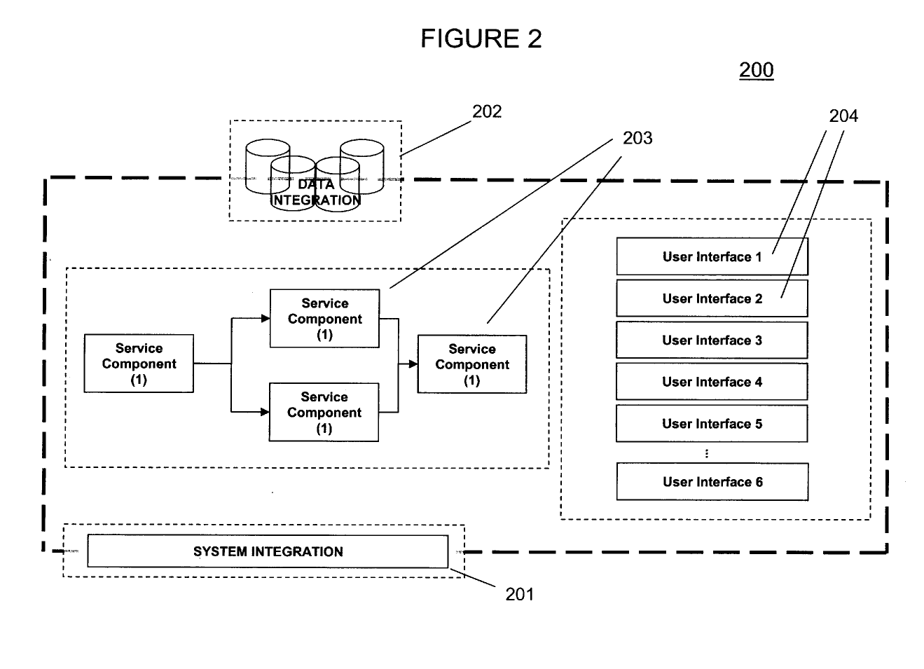

As shown exemplarily in FIG. 2, the integrated methodology 201 of the present invention and its resultant tool includes a layered architecture and framework 200 which support data integration across different data sources 202 and in different data format. It also has been designed with generic service components 203 to wrap different analytical models and also to make them easy to be changed if a new model has been developed or the underlying framework has changed. This framework consists of user view components 204 to support different user roles.

For example, there are demand forecasting view components which can be assembled into both workforce capacity planner's work bench as well as the sales-side sales principle's work bench. User access control is enforced when the same view component is rendered in different user role's work benches, so that a different user is able to see/change the only data which he/she has the right to view and modify.

Workforce management typically involves a lot of different data (sales data in pipeline, on-going contracts, etc.) to supply side (dynamic staffing availability, etc.). The ability to use all these data in an automated fashion eliminates the need for manual processing, input, validation, etc. and also compresses the time needed for many operations.

The workforce cycle typically includes many different operations (e.g., demand forecasting and capacity planning), and ideally it would be desirable to implement them all quickly and effectively. The structures of these generic service components are defined by the data requirements of those operations, as well as the interface among those operations. For example, in an exemplary specific tool described in the first co-pending application that implements the generic framework of the present invention, the stochastic nature of the work force demand is estimated by advanced statistics models, and the statistics are fed to the capacity planning module, which optimizes the actions under the uncertainty. The second of the above-identified co-pending applications demonstrates the type of stochastic analysis that could be used in specific tools that take advantage of the integrated framework implemented by the present invention.

As suggested by FIG. 2, such a system 200 will also have many different users, and more importantly, user categories. Let us use as a non-limiting example a company (or a business unit) that provides information technology (IT) infrastructure services.

For such a company, key stakeholders in the workforce cycle typically might include: sales (teams who sell solutions and reach to clients), development (teams who develop solution and architect new technologies), planning (teams who decide how the existing projects will be staffed and delivered, both in short-term and long-term horizons), delivery (teams who assign resources to projects and deliver the project to customers), HR (who decide and implement hiring, re-skilling, and other resource actions and policies), strategy (teams who decide on longer-term business objectives), finance (who implement metrics and measurements to evaluate the success of the organization). Therefore, there is the need for different user interfaces for the different users.

Such an embodiment 200 could include a workforce system with scalable optimization capabilities and system architecture across the complete workforce management life cycle. At the core of the system are analytical capabilities to: 1) automatically develop (or readjust) skills taxonomy and design bills of materials for existing engagements, 2) forecast demand for projects and resources, 3) optimally allocate individuals to opportunities, while taking into account specific preferences and business rules, 4) predict future “gaps” and “gluts” in workforce given the demand for human resources and available supply, and 5) develop capacity plans by taking into account demand and supply uncertainty, business objectives and risk preferences. From these core methodologies a system architect could derive new capabilities, to address specific needs and connect different user segments, such as sales, planning and delivery organizations.

For example, for the sales people, there could exist a customized view to answer questions such as: “Can I promise this deal to a customer within certain time and price limits?”, “For a given opportunity, what are the trade-offs between time and price?”, “Given current state of workforce resources, what offerings should the sales force promote?”.

For the teams involved with delivery, one could “match people to projects, generate recommendations for staffing individual resources to the project that are feasible while adhering to the business rules for staffing”, “Determine the optimal usage of resources (from a profit perspective)”.

For the teams involved in planning, one would address issues such as:

What are the best capacity staffing levels for each skill to maximize profits,

What are the risks of losing an engagement given the current staffing levels,

How the current staffing level deviates from what was expected, and

What hiring, retraining, firing, etc., actions should be taken for each skill based on demand, supply, gaps/gluts, revenues from engagements and costs for skills?

Again, it is noted that these different views, requirements, and capabilities are properly considered as being implemented on top of the generic foundation provided by the integrated framework of the present invention, and that the generic framework of the present invention can even serve alone as a management mechanism and tool. Therefore, it is also again noted that the first above-identified co-pending application is one non-limiting example of a specific workforce tool that can be implemented to benefit from the integrated framework of the present invention.

There are numerous ways of how these individual capabilities could be implemented. Examples include: 1) statistical methods and predictive modeling to compute demand/supply forecast, 2) stochastic loss network model for general risk-based workforce management under uncertainty and a stochastic optimization framework for general risk-based capacity planning under uncertainty, including the determination of optimal planning actions, 3) linear programming to assign individual resources to existing opportunities, while respecting the business rules for staffing, 4) and the service-based system architecture that enables flexible solution reusability, 5) data warehousing techniques to manage and integrate different data sources, etc.

The second of the above-identified co-pending applications provides an example of a method of glut/gap analysis based on stochastic methods that is related to some aspects of the present invention and could even be used as a subcomponent of an implementation of the present invention.

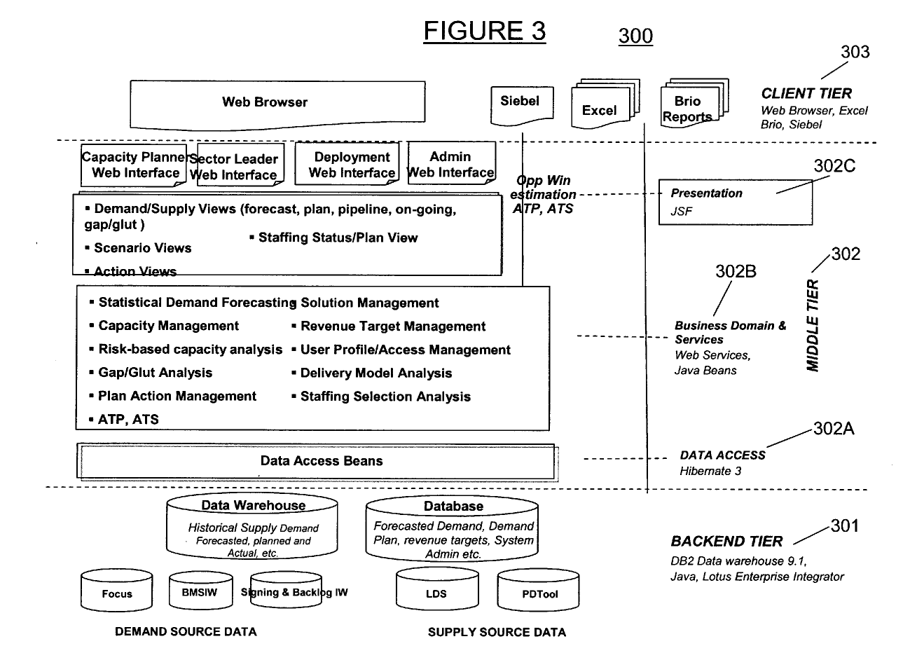

One such specific embodiment of the present invention is exemplarily illustrated in FIGS. 3-5. These figures describe an exemplary embodiment of a robust service-oriented architecture that integrates advanced workforce analytics with the unified data repository of the present invention, and allows for quick and seamless integration of new solutions, capabilities and users, as discussed in more detail in the first of the above-identified co-pending applications. Thus, comparing FIG. 2 with FIG. 3, the present invention, exemplarily shown in FIG. 2 as the generic integrated framework of the entire organization workforce, can be viewed as the lower layers of the architecture 300 shown in FIG. 3.

That is, the present invention, as exemplarily embodied in the integrated framework of FIG. 2, can serve as the foundation for any number of specific embodiments and specific tools that provide the service components and user interfaces required by specific organizations, including the specific embodiment shown in FIG. 3 and discussed in the first of the above-identified co-pending applications. Other specific workforce tools are possible, and it is noted in passing that the specific tool described in more detail in the co-pending application could also be based on another foundation than that described in the present invention.

FIG. 3, therefore, presents one exemplary system integration architecture 300, which shows the tier design of the system, the bottom layer 301 is the backend tier, EIS (enterprise information system) tier, which will be explained in detail in the next chart and which is an exemplary embodiment of some of the aspects of the present invention.

In the middle tier 302, it also composes three layers, including a data access layer 302A, a business domain and services layer 302B, and a presentation layer 302C. The data access layer 302A maps the relation world (relational data tables in the backend tier) to the object work (the java objects in the middle tier), which makes the entities in the middle tier 302 to be loosely coupled with the data base design. Most the work in the middle tier 302 is done in the business domain and service layer 302B where the business domain logic is implemented.

The Business Domain and Services Layer 302B is implemented using a Service Oriented approach. A generic wrapper is designed to quickly turn an analytical model into a service component (FIG. 2, label 203) that is able to interact with the rest of the system. On top of the business domain and services layer various modular view components 302C are designed, which can be assembled into different workbench for various user role types.

The upper tier 303 above the middle tier 302 is the client tier. Presently, with the component and service oriented design, the system is able to support various clients, including web browsers, MS Excel, all through web services interfaces. Also the service components, such as a statistical opportunity win estimation module, and available to promise module, and an available to sell module, are able be used by other systems as well.

It can be pointed out that the service components 202 and user interfaces 203 of FIG. 2 show up in FIG. 3 as implemented in the middle and upper tiers 302,303.

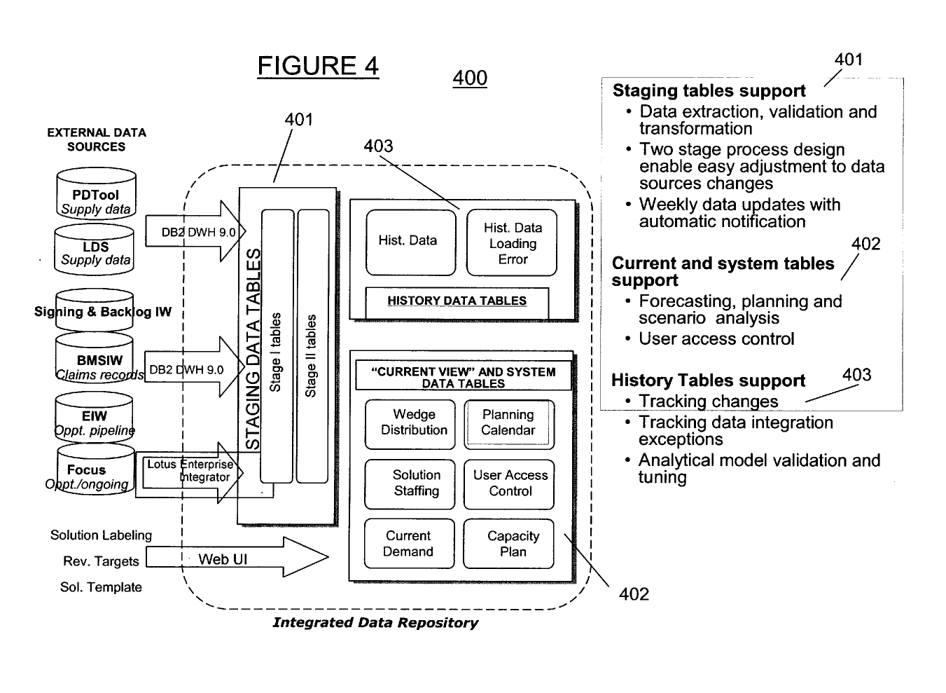

FIG. 4 depicts one possible approach 400 for data integration within such architecture as shown in FIGS. 2 and 3, to manage and integrate a large number of data sources into a unified repository, thus eliminating the need for manual data collection, processing and validation. The success of a system cannot go without good quality data.

The data integration plan of FIG. 4 has exemplarily been designed as a three-step process for data integration.

1. The first step is to compose two staging sub steps with the stage I tables that bring data from external data sources (stage I tables have almost exact format of their counter parts in the external data sources). The data validation/transformation is done in the stage II tables through intensive data validation, based on system defined reference tables. Only valid data past the first step will be ready to get into the “current view”, which will be used to support run time system functionalities. This two-stage design enables easy adjustment to data source changes, and ensures that the performance of the system will not be affected by errors and by time consuming data validation processes.

2. The second step is the data loading process from the staging II tables to the “current view” tables. During this step certain business rules are implemented. For example, for capacity planning, a certain revenue threshold is applied to filter out very small revenue opportunities. This type of business rules is preferably implemented in the second step in data integration layer, rather than within the other system layers, because this approach provides better performance and flexibility to changes.

3. For the third step, when new data is read from the first step and “current view” data is rolled out and loaded into the history tables. With the rich history tables, the work force system supports tracking changes and exceptions from data integration. Also, the history data is critical for building robust analytical models and supports its validation and tuning.

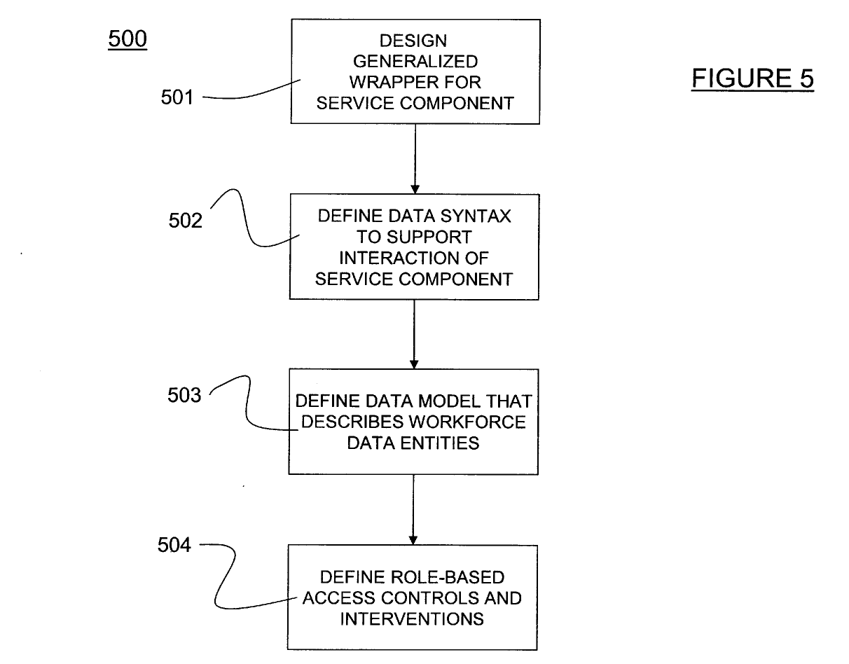

FIG. 5 shows a flowchart 500 that exemplarily demonstrates the steps one needs to follow to take the generic framework of the present invention, as shown in FIG. 2, into a more specific architecture, such as shown in FIG. 4.

In step 501, a generalized wrapper is designed for a service component (e.g. specify the semantics of inputs/outputs that define the service). In step 502, the data syntax to support the interaction of service components is defined. In step 503, a data model that describes workforce data entities that can handle various data types and formats (e.g. manual entry, flat file, database entry) is defined. In step 504, role-based access controls and interventions (e.g. for each data source and service component can have “owner” and “reviewer” role with different access privileges, who can update the data or run the service vs. automatic update) are defined.

Having executed these steps, the system designer can then implement the method into an architecture, such as exemplarily demonstrated by FIGS. 2-4.

### Exemplary Hardware Implementation

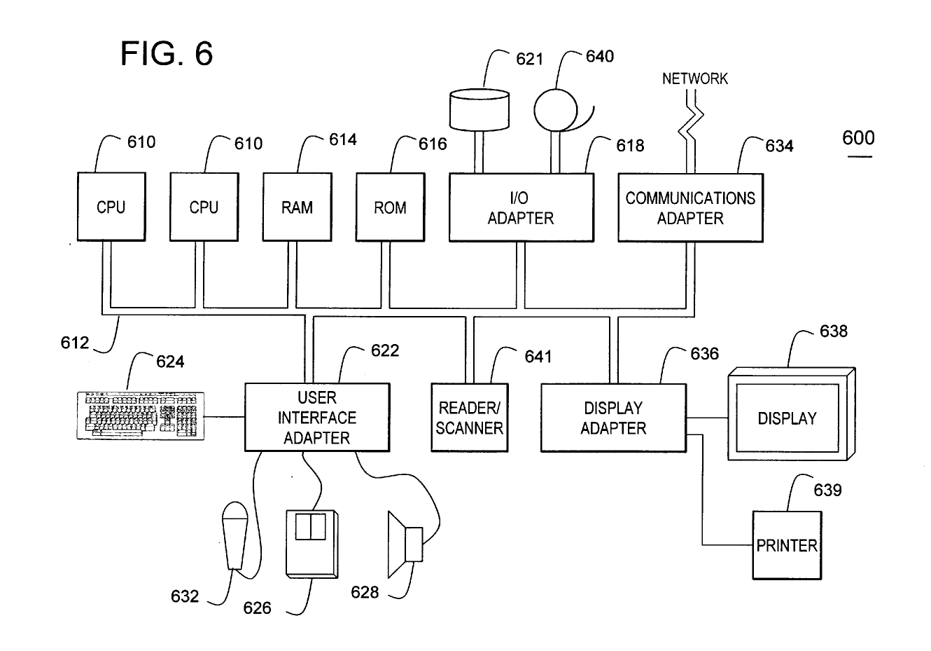

FIG. 6 illustrates a typical hardware configuration of an information handling/computer system in accordance with the invention and which preferably has at least one processor or central processing unit (CPU) 611.

The CPUs 611 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting an information handling system to a data processing network, the Internet, an Intranet, a personal area network (PAN), etc., and a display adapter 636 for connecting the bus 612 to a display device 638 and/or printer 639 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 611 and hardware above, to perform the method of the invention.

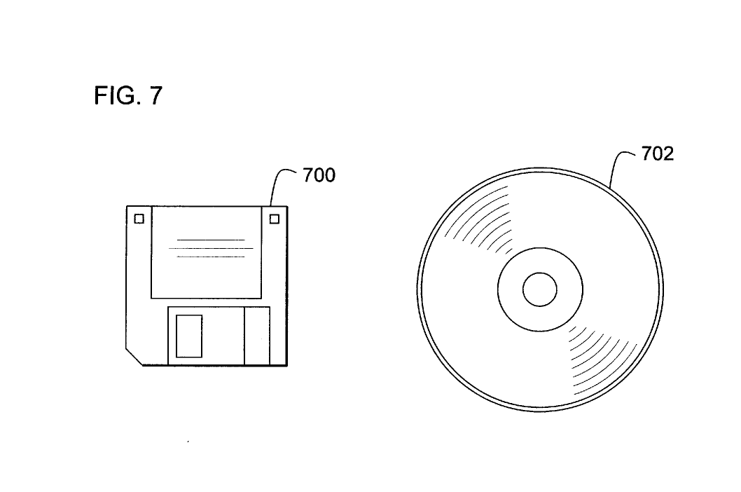

This signal-bearing media may include, for example, a RAM contained within the CPU 611, as represented by the fast-access storage for example. Alternatively, the instructions may be contained in another signal-bearing media, such as a magnetic data storage diskette 700 (FIG. 7), directly or indirectly accessible by the CPU 611.

Whether contained in the diskette 700, the computer/CPU 611, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

Automation of the workforce planning process and compression of cycle time, better and faster response to changes in the demand and in the market place, better revenue growth, better cost control, higher profitability, more appropriate utilization of the workforce and lower risk of loosing engagement.

While the invention has been described in terms of a single exemplary embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method of creating a generic architecture for end-to-end workforce management, said method comprising:
identifying sources of data that together reflect data of substantially an entirety of a workforce of an organization;
identifying service components related to said workforce; and
combining said data sources and said service components into an integrated framework to support an end-to-end workforce management cycle.

2. The method of claim 1, wherein said data from said plurality of data sources is provided into a data integrator that provides an automatic data extraction from said plurality of data sources to provide a unified repository of data related to said workforce.

3. The method of claim 2, wherein said data integrator further provides at least one of a validation and transformation of said extracted data.

4. The method of claim 1, wherein said identifying service components further comprising identifying interfaces appropriate for said service components.

5. The method of claim 1, wherein each said service component provides a user of a service component a localized perspective of said integrated framework by selectively providing access to all data of said workforce that is related to said service component.

6. The method of claim 1, wherein said integrated framework comprises a multi-tier framework architecture, allowing said tool to be readily expandable for data sources, service modules, and user interfaces.

7. The method of claim 1, further comprising:
implementing said integrated framework to manage said workforce.

8. The method of claim 1, wherein said combining comprises:
developing one or more tool modules for representing one or more of said service components by defining one or more data sources and data formats for said tool modules.

9. The method of claim 8, wherein said development of said one or more tool modules comprises one or more of:
designing a generalized wrapper for a service component;
defining a syntax to support interactions with said service component;
defining a data model that describes workforce data entities that can handle data formats for said service component; and
defining one or more role-based access controls and interventions for said service component.

10. The method of claim 1, wherein said integrated framework comprises one or more computerized tools designed for specific service components.

11. A signal-bearing medium tangibly embodying a program of machine-readable instructions executable by a digital processing apparatus to function as one or more of said computerized tools of claim 10.

12. A computer as executing one or more components of said integrated framework of claim 10.

13. A method of implementing an integrated end-to-end workforce management framework, said method comprising at least one of designing and implementing:
an extensible infrastructure for implementing a plurality of individual service components related to said workforce;
an extensible multi-component infrastructure to support interactions among the service components;
a unified data model to accommodate automatic data feeds, multiple data sources, and human inputs related to said workforce; and
a data flow control mechanism.

14. The method of claim 13, wherein said implementing comprises at least a partial computerization of at least one of said extensible infrastructure, said extensible multi-component infrastructure, said unified data model, and said data flow control mechanism.

15. The method of claim 13, further comprising:
designing and implementing a unified environment to accommodate human intervention to said integrated end-to-end workforce management framework..

16. The method of claim 13, further comprising:
adding one or more of new service components, users, and interfaces to said integrated end-to-end workforce management framework.

17. The method of claim 14, further comprising:
providing for a plurality of modes of operation for said integrated end-to-end workforce management framework, said plurality of modes including one or more of:
a hosted mode;
a stand alone mode;
an off-line mode; and
an on-line mode.

18. An integrated end-to-end workforce management framework, comprising:
an extensible infrastructure implementing a plurality of individual service components related to said workforce;
an extensible multi-component infrastructure supporting interactions among the service components; and
a unified data model accommodating automatic data feeds, multiple data sources, and human inputs related to said workforce.

19. The integrated end-to-end workforce management framework of claim 18, wherein at least one of said extensible infrastructure, said extensible multi-component infrastructure, said unified data model further comprises a data flow control mechanism and a computerized mechanism.

20. A signal-bearing medium tangibly embodying a program of machine-readable instructions executable by a digital processing apparatus to execute the computerized mechanism of claim 19.
